(19) United States
(12) Patent Application Publication
(10) Pub. No.: US 2006/0208653 A1
(43) Pub. Date: Sep. 21, 2006

(54) Circuit improvements for solar lamps

(75) Inventor: John Crawford, Hendon, South Australia (AU)

Correspondence Address: AKERMAN SENTERFITT, P.O. BOX 3188, WEST PALM BEACH, FL, 33402-3188, US

(73) Assignee: Integrated Electronic Solutions Pty Ltd, South Australia (AU)

(21) Appl. No.: 10/545,479

(22) PCT Filed: Mar. 8, 2004
(86) PCT No.: PCT/AU04/00281

§ 371 Date: Apr. 3, 2006

(30) Foreign Application Priority Data
Mar. 7, 2003 (AU) 2003901027

(51) Int. Cl. H05B 41/36

(52) U.S. Cl. 315/150; 362/183

(57) ABSTRACT

A solar powered lamp arrangement where there is a solar photo-voltaic panel array controllably connected to a battery storage providing with such control a supply of direct current to at least one light emitting diode, and a switching arrangement with means to detect, by reference to the output of the array, the level of ambient light, and an electrical connection between at least one said light emitting diode and the battery storage so that the light emitting diode or diodes will, when the ambient light is below a selected threshold, be connected to effect a light output the arrangement being further characterised in that, in a supply connection from the solar panel array to the light emitting diode or diodes there is a further unidirectional current conducting unit which is not a Schottky diode.

### TECHNICAL FIELD

This invention relates to an arrangement where a solar panel is adapted to charge a rechargeable battery, and also switch off a lamp drive while the battery is being charged.

### BACKGROUND ART

As is discernable from some prior art which however is not considered to be necessarily common general knowledge in Australia, circuits are known for the control of solar powered lights (such as a solar powered walk light). In particular these include U.S. Pat. Nos. 5,041,952, 5,086,267 and 5,221,891. In these a solar panel charges a rechargeable battery, and also switches off the lamp drive while the battery is being charged.

As is evident they employ a small number of components, and enable good control of the lamp drive at low cost.

Since these were filed some improvements have been made to their circuits, and it is of interest to examine the operation of circuits currently being manufactured. Not only to assess the improvements, but also to seek further improvements.

FIG. 1 shows a circuit that is typical of current practice. In this circuit the 4.5 volt solar panel 1 provides an output voltage of 4.5 volts when unloaded. As it is loaded the voltage falls a little until it reaches the knee voltage where all carriers produced in the photo-voltaic junctions are being delivered to the load, and it saturates, with the voltage falling as the load resistance is decreased, but with the current remaining substantially constant.

This current is steered into the 2.4 volt rechargeable battery 2 via a low forward voltage Schottky diode 3. As is well known, the output voltage of a typical single cell of a silicon photo-voltaic panel is around 0.6 volts, and a rechargeable nickel-cadmium cell has an operating voltage of 1.2 volts. So in this circuit eight series connected segments of silicon are needed to achieve a desired output voltage of a nominal 4.3 volts (remembering that the output voltage of a solar photo-voltaic cell falls off by about 2 mV for each degree of increasing temperature). This voltage must be sufficient under partial illumination (even with the warmth of the sunlight) so that the solar cell output voltage is sufficient to charge the battery.

While the energy of the incident photons must be sufficient to develop the photo-voltaic voltage across the band gap barrier of the PN junction, this voltage is not so dependent on the intensity of the incident light. But the current carriers that are generated are directly in proportion to the incident light intensity.

The diode 3 is needed so that in darkness the voltage on the photo voltaic cell is isolated from the battery voltage, and its collapse is able to turn on the light emitting diode 4.

A resistive voltage divider made up of resistors 5 and 6, divides the output voltage of the photovoltaic cell, and applies an appropriate voltage to transistor 7. The collector current of this transistor serves to cut off the base of the output drive transistor 8 which is driven from the battery through resistor 9.

As is evident, this circuit is considerably simpler than the original circuits described in the earlier patents, although apart from the immediately obvious change to use a Light Emitting Diode to generate the light output, the principle of operation remains the same as those described in the above-mentioned patents.

The Schottky diode would have been chosen in order to obtain a minimum forward voltage drop at the maximum charging current. If the maximum output voltage from the solar panel is close to the battery voltage plus the forward voltage drop of the Schottky diode, operation will be in the knee region and any lowering of the diode forward voltage drop will assist in additional charging current. Otherwise a cheaper diode will make no difference to the charge rate even though extra voltage is dropped across the diode.

If there is still a voltage margin available, fewer cells in the solar series array can be used. For example 6 series cells should be sufficient to provide the same charging current in this circuit, and still leave sufficient voltage margin above the battery voltage to allow full charging current.

An improved circuit according to these features is shown in FIG. 2.

Only four photo-voltaic junctions in series (2.4 volts nominal charging voltage) in this case are used in the photo panel 10 charging the battery. The single battery cell 11, at 1.2 volts, allows an excess charging voltage over the forward voltage drop of the Schottky isolating diode 12.

This circuit uses a simple inverter circuit in which the output transistor 13 is turned on by a base current derived from the output of the switching control transistor 14. The inductor 15 presents inductive opposition to the increase in current flow from the battery 11 through the output switching transistor 13. The rise of current is at the rate is di/dt, with L×di/dt=the voltage forcing the increase in current. Ignoring second order effects caused by resistance, the forcing voltage is the battery voltage minus the saturation voltage of the transistor. However, because of the characteristics of the transistor 13, there is a current level at which the transistor begins to move out of saturation, and its collector emitter voltage begins to increase.

The increasing voltage on the collector of the output transistor is capacitively coupled by capacitor 19 back to the base of the switching and control transistor 14, and drives its base voltage positive cutting it off, and cutting off the drive current to the base of the output transistor. Thus there is positive feedback, and the output transistor is turned completely off.

The stored energy in the inductor 15 rapidly increases the collector voltage of transistor 13, and this will continue to increase until another current path is able to accept the current in the inductor. Through a Schottky diode 16, the current in the inductor is steered into the charge storage capacitor 17. This charges the capacitor to a voltage that is sufficiently large to forward bias the Light Emitting Diode 18 into its light emitting mode. A white light emitting diode has a typical forward voltage of 3.2 volts, a voltage considerably larger than the 1.2 volts available from the battery. Thus the forcing voltage setting the rate of decrease in the current in the inductance during the off time is the LED voltage of 3.2 volts plus the Schottky diode voltage of typically 0.4 volts minus the supply voltage (1.2 volts).

As this voltage opposing the flow of current in the inductance is greater than the battery (less the saturation voltage) voltage that established the inductive current, the rate of fall in current is greater than the rise. Therefore the charging duty cycle is proportional to the ratio of the forcing voltage driving the increase in the current in the choke (1.2 volts minus the output transistor VCE(SAT)), to the load voltage minus the battery voltage, and is not dependent on the inductance.

If the time constant of the base drive resistor 20, connected to the base of the control transistor 14, and the feedback capacitor 19, is greater than the delay to the time when the current in the inductor 15 has fallen to zero, then the voltage on the collector falls rapidly toward the battery voltage of 1.2 volts. It falls rapidly, and this falling voltage is coupled via capacitor 19 to quickly drive the control transistor 14 on and restart the drive cycle with the output transistor being turned back on and a new cycle starting.

The diode 21 provides a switching signal to turn off the light output when the output of the solar panel is a voltage large enough to cut off the base of transistor 14. Thus the light is switched off when the panel voltage reaches the battery voltage, although charging will not begin until the output of the solar panel rises further to forward bias the Schottky charging diode 12.

In another operating mode, if the time constant of the capacitor 19, and its timing resistor 20 is short compared to the inductive charge time, another operating mode can be established where to RC time is concluded, and transistor 14 begins to turn on before the current in the inductance 15 has fallen to zero. In this case as the output transistor begins to turn on it pulls the collector down and the current in the inductance that is already flowing is augmented by increasing current from this point Either mode of operation is viable.

The duty cycle is fixed by the ratio of the two forcing voltages (forcing the rise and fall of current in the inductor 15), and the brightness of the Light Emitting Diode can be altered by varying the current level at which the output transistor 13 begins to pull out of saturation. Apart from the inherent characteristics and structure of the transistor, its base current can be varied to adjust the current level at which the rate of rise of collector voltage is sufficient to activate the switching action. Therefore selection of the resistor 22 will allow setting of the typical output current drive to the LED.

This circuit is one of the simple circuits available to provide an inverter with output at a higher voltage than the input circuit

The reduction in cost by halving the number of cells in both the solar photo-voltaic charging device, as well as reducing the battery to a single cell, will more than cover the added cost of a few components and an inductance.

In a product which is manufactured in quantities of some millions, a small cost saving can result in very significant amounts of money that can be saved.

I have discovered and it is an object of this invention in relation to a circuit of this type that there can be some significant economic savings.

### DISCLOSURE OF THE INVENTION

In one form then the invention could be said to reside in a solar powered lamp arrangement where there is a solar photo-voltaic panel array controllably connected to a battery storage providing with such control a supply of direct current to at least one light emitting diode, and a switching arrangement with means to detect in connection with any electrical supply status from the array that this is below a selected threshold value, and such that the switching arrangement is adapted to effect, upon the said means detecting said lower than said threshold value status, an electrical connection between at least one said light emitting diode and the battery storage so that the light emitting diode or diodes will thereby be connected to effect a light output the arrangement being further characterised in that, in a supply connection from the solar panel array to the light emitting diode or diodes there is a further unidirectional current conducting unit which is not a Schottky diode.

In preference, the unidirectional current conducting unit is a transistor and means to maintain this when operating in a mode close to saturation mode.

In preference, the close to saturation mode is maintained by providing a drive applied to the transistor which is less than 3% of a charging current being applied to the battery storage

In preference, the unidirectional current conducting unit is an integrated circuit adapted to provide a unidirectional effect.

In preference, a positive output of the battery storage and a positive terminal of the solar panel array are electrically connected in common.

In preference, the unidirectional current conducting unit includes an input transistor connected to an output of the solar array, and a voltage reference means which are adapted to effect selection of the threshold value.

In preference, the voltage reference is voltage divider.

In preference, in the alternative, the voltage reference includes at least two diode connected transistors and a current source.

In preference, the input transistor is an NPN transistor.

In a further preferred form of the invention, the NPN transistor has an inverse structure characterised in that an n-type island is adapted to be an emitter of the transistor and at least two n-type diffused regions in a p-type base are adapted to be collector outputs.

In a further preferred form of the invention, there is included circuitry adapted to convert a direct current voltage drawn from the battery storage to an alternating current of higher voltage and to supply such higher voltage to the light emitting diode.

In preference, such higher voltage is connected so that it will be applied directly to the light emitting diode or diodes and the light emitting diode or diodes then are without any storage capacitor across any respective diode.

In a further form the invention could be said to reside in a circuit generally for the purposes described where there is a solar photo-voltaic panel connected through to a battery storage and a switching arrangement such that in the event of reduced or no output from the panel then the circuit effects an electrical connection to a light emitting diode from the battery storage characterised in that in a supply connection from the solar panels there is a unidirectional unit which is not a schottky diode.

In preference in one instance this is a normal junction diode.

In another instance this is an integrated circuit which is adapted to provide a unidirectional effect.

In the alternative there is a further improvement where the solar photo-voltaic panel which currently has eight series segments is reduced in segment numbers. In preference this can be reduced to four in one instance.

### BRIEF DESCRIPTION OF THE DRAWINGS

For a better understanding of the invention it will now be described with relation to preferred embodiments and drawings wherein:

FIG. 1 shows a prior art circuit for a solar lamp power supply that is typical of current practice,

FIG. 2 shows a prior art circuit for a solar lamp power supply that is known, but is an improvement on typical practice,

FIG. 3 shows a theoretical circuit diagram of an embodiment of the invention,

FIG. 4 shows a simple practical circuit for an embodiment of the invention,

FIG. 5 shows a basic exemplary circuit to achieve the low voltage isolation without a Schottky diode,

FIG. 6 shows a more practical version of the embodiment of FIG. 5,

FIG. 7 shows an output drive circuit in which some useful design techniques available with integration into a silicon chip are used,

FIG. 8 shows a practical circuit realisation to provide a detection threshold for the input from the solar panel at an appropriate sensitivity to control the output drive at dusk,

FIG. 9 shows an improved circuit for the embodiment of FIG. 6,

FIG. 10 shows an improved realisation of the embodiment of FIG. 9, where the current mirror of FIG. 9 has been replaced by a transistor amplifier,

FIG. 11 shows a graph of the forward voltage drop against current for the embodiment of FIG. 10 against the characteristic of a typical Schottky diode,

FIG. 12 is an embodiment of an improved circuit of the embodiment of FIG. 7 wherein the oscillator and output drive has been improved in the suggested circuit shown in FIG. 12,

FIG. 13 shows an oscillator and output drive circuit used in an integrated circuit chip embodiment of the invention, and

FIG. 14 illustrates a circuit symbol and an equivalent circuit for an injection logic gate.

### DESCRIPTION OF BEST MODES FOR CARRYING OUT THE INVENTION

Prior art circuits have been manufactured for some years in millions of lamps per annum I have discovered that there are some circuit changes possible which will make production less expensive.

The Schottky diode 16 is used to isolate the charged capacitor from the drive transistor, so that the capacitor is not discharged when the output drive transistor is switched on.

A Schottky diode has an abrupt junction which results in a lower forward voltage at its operating current levels, although it costs more than typical diffused PN junctions.

I have realised that excess voltage does not increase the charging efficiency by any significant amount (apart from when operating close to the I/V knee in the characteristic curve of the output of the photo voltaic cell). The battery loads an output of the solar cells, and prevents the voltage rising above the battery voltage. Therefore the solar cells are operating in current output mode, and any potential extra voltage is not available.

However, at a peak current of less than 100 mA in a typical circuit, its forward voltage drop of 0.4 volts is about one half of the voltage drop if a fast diffused PN diode had been used. This would add 0.4 volts to the voltage out of the inductor during the charging phase. That is increasing the required drive voltage from 3.6 volts to 4.0 volts: an increase of only about 10%. If this drive voltage is increased by 10%, then the efficiency of the circuit (and the expected time before the energy stored in the battery is used up) is only decreased by 10%. Not a significant saving to cover the additional cost of using a Schottky diode.

However, the light emitting diode is itself non-conducting below its knee voltage (about 2.8 to 3 volts). At a high frequency the light output is hardly different from the same average DC current being replaced by a pulsating signal. Therefore we have found that omitting the capacitor 17 makes no detectable difference to the LED brightness. Once there is no capacitor the diode also becomes superfluous, with a corresponding improvement in circuit efficiency because of the lower drive voltage (for example 3.2 volts) presented by the Light Emitting Diode.

In a further form of this invention therefore this can be said to reside in a circuit of this type in which a solar panel is adapted to charge a rechargeable battery, and also adapted to switch off the light emitting diode while the battery is being charged from the solar panel characterised in that the circuit is adapted to effect an output to the light emitting diode directly rather than through a unidirectional junction such as a diode and where there is no bypass capacitor across the light emitting diode.

A further small cost reduction is available from the diode used to switch the Light Emitting Diode off during the day while the battery is being charged. As the current in this diode is only about 1 mA, a small signal diode can be used at a not inconsiderable cost saving.

In both of these circuits, even though their component list is made up of only a few inexpensive components, I have discovered it is possible to further reduce the cost by putting the active part of the circuit into an integrated circuit A single silicon chip of an area of around three times the area of the output transistor can replace the active components, with the exception of the inductor.

However there is some difficulty in devising a means of achieving the function of the Schottky diode. A diffusion process which includes a Schottky diode mask step might achieve this, but in bipolar design such processes are uncommon. A circuit is therefore proposed which will give the equivalent function as the Schottky diode at comparable efficiency and performance.

In the bipolar diffusion processes that are generally available, PNP transistors are unable to handle large current, and exhibit relatively low gains, only NPN transistors have a good chance of providing the performance required. In addition, the VBE of a typical emitter base junction when it is forward biased is 0.7 volts, and to provide adequate control and drive from a 1.2 volt supply is difficult.

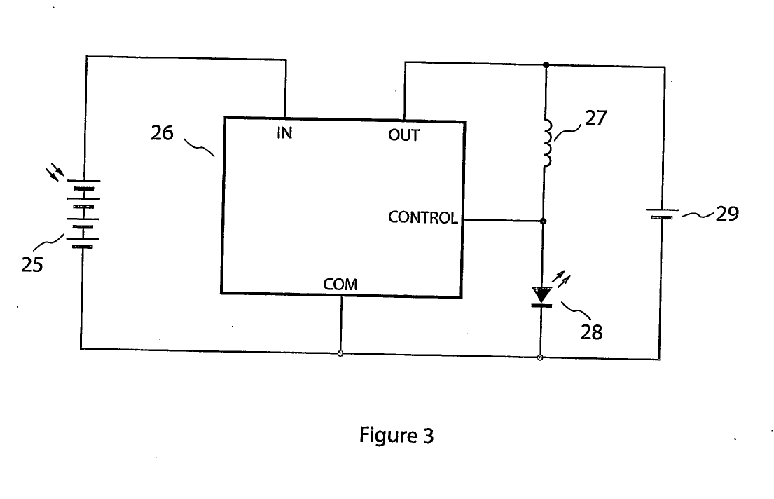

FIG. 3 shows the kind of circuit which can be possible using a monolithic bipolar integrated circuit 26. The solar photo-voltaic cell 25 provides 2.4 volts to pin IN of the integrated circuit. When charging the CONTROL pin is held off, and a charging current flows out of pin OUT. The common connection is from pin COM. Thus if this circuit was possible, an appropriately small silicon chip can be packed in a sub-miniature four pin package, replacing all of the components of circuit 2, with the exception of the inductor. Similar circuits can be drawn to replace circuit 1, as well as to operate at other voltages.

However the problem in this configuration is that the PNP transistor that might be used to carry the charging current from the solar cell to the battery is incapable of carrying the current, or of providing a sufficiently low voltage drop to provide a comparable efficiency to the circuit currently being used.

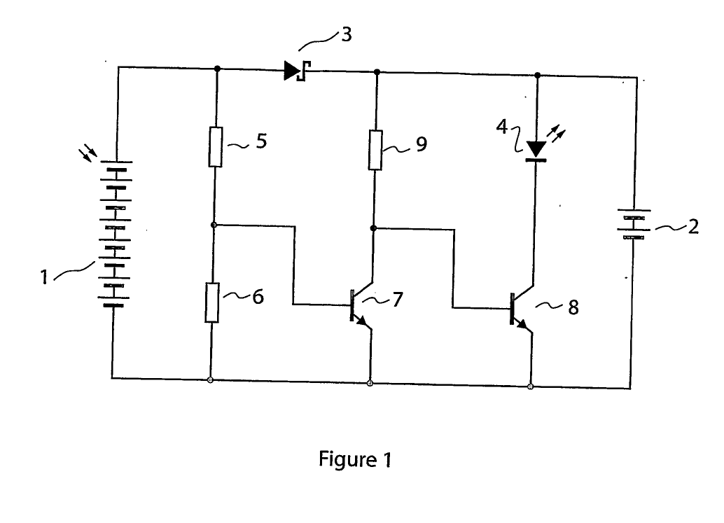

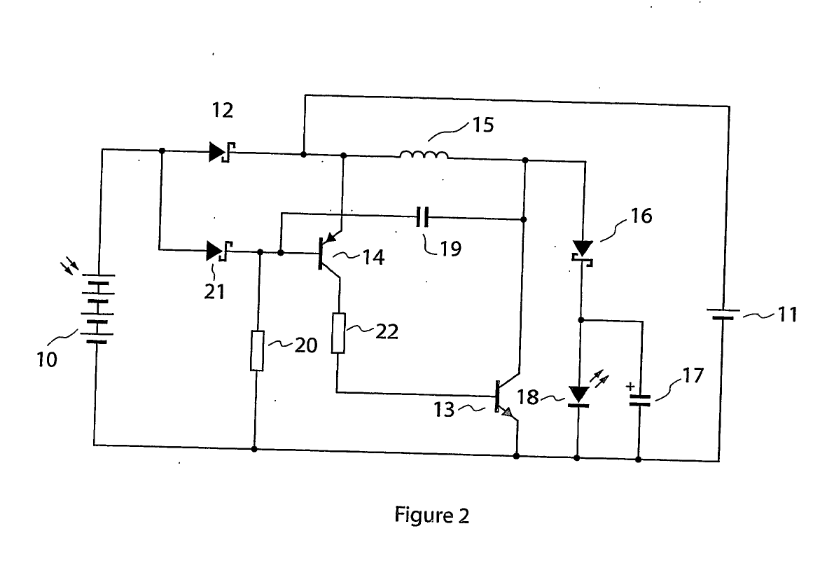

To meet the necessary requirements within the limitations of typical bipolar design parameters, I control the current flow in the negative side of the circuit. Thus the positive becomes the common reference to the solar array and the battery, and the isolation of the charging circuit which in FIG. 1 and FIG. 2 is provided by the Schottky diode, will be provided by an NPN transistor.

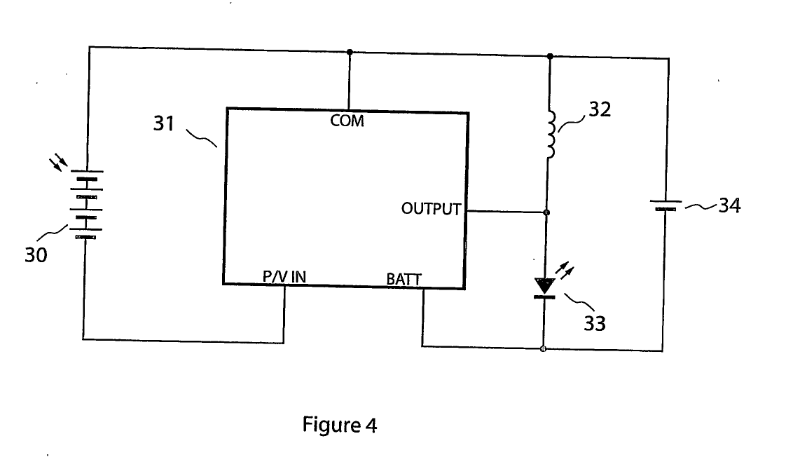

In FIG. 4 this new approach is shown. The positive to the solar array and the battery is now pin COM, and the COM pin of FIG. 3 is split to give a negative P/V IN from the solar photo-voltaic panel, and a BATT-terminal that connects to the negative battery terminal, and the cathode of the light emitting diode.

In an equal manner the simpler, high voltage circuit, of FIG. 1 can be integrated in the same way, replacing the Schottky diode with an integrated circuit based on an NPN current pass transistor, using a similar control circuit design approach to give ON/OFF control between day and night.

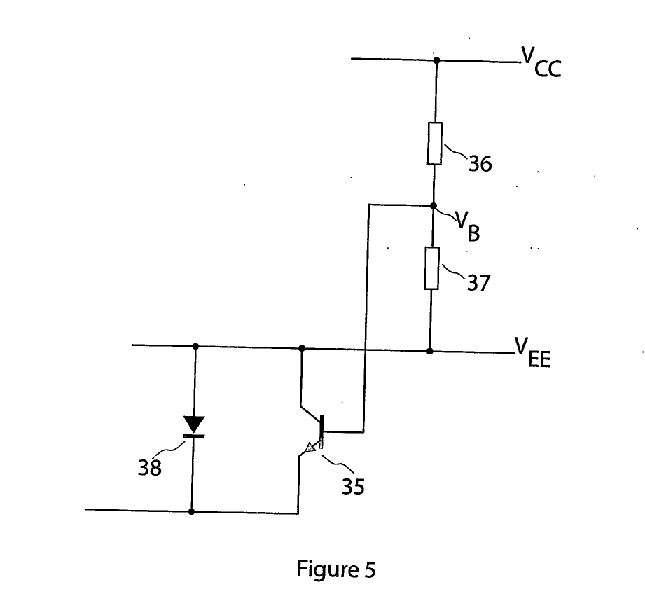

A basic circuit to achieve the low voltage isolation that is needed to replace the Schottky diode is shown in FIG. 5. VCC and VEE are connected to the battery positive and negative respectively, and a voltage divider is provided by resistors 36 and 37, to give a voltage VB, to typically 0.4 volts above VEE.

This voltage is applied to the transistor 35, which has a sufficient area to provide a good saturation voltage with the available base drive, and the maximum charging current offered by the solar array.

As the emitter of transistor 35 is pulled negative, base current will flow to turn it on, and most of the emitter current will flow in the collector circuit to the battery negative. As more base current is required to maintain the transistor bias, the impedance provided by the equivalent circuit of the voltage divider made up of resistors 36 and 37, will allow the base voltage to become more negative, matching the increase in collector emitter saturation voltage as the current flow increases. In principle this could provide an appropriate replacement for the Schottky diode.

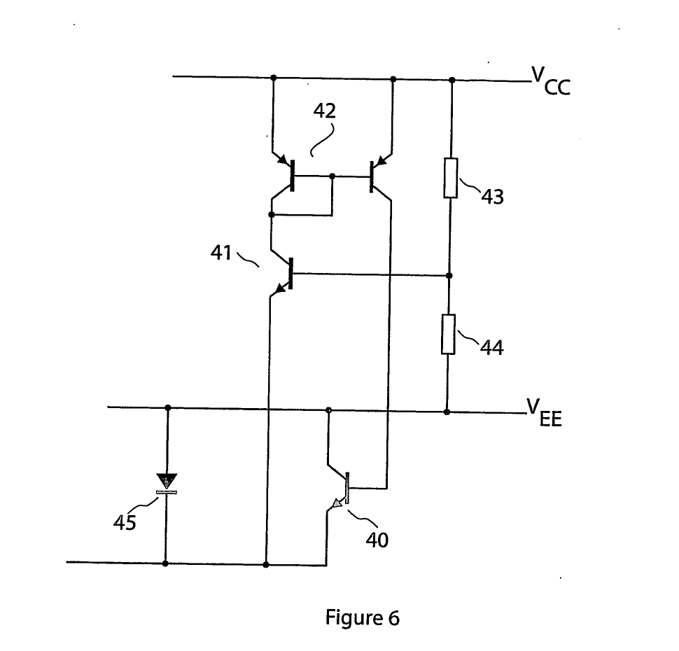

A further enhancement of this is shown in FIG. 6, where the main transistor 40 is supplemented by the addition of a second transistor 41, which is biased at 0.4 volts (but with a higher impedance divider) with respect to VEE by resistors 43 and 44. However in this circuit the current from the collector of transistor 41 is mirrored in the PNP transistor current mirror pair 42 to provide base drive to the main current carrying transistor 40.

In this circuit, at low current, a low base drive is needed, while at higher charging current more base drive is provided only when required. In the first example in FIG. 5 the limitation in its performance is provided by having a sufficiently low base drive impedance via the resistor divider network. This is a totally wasted current while not charging, whereas the circuit of FIG. 6 uses a much smaller current in the voltage divider.

Diodes 38 and 45 are shown in FIGS. 5 and 6 connected from the negative solar array output terminal to VEE, the battery negative terminal. When the battery is completely flat, then these diodes are needed to carry the initial charge into the battery, to raise its voltage sufficiently for the circuitry in the integrated circuit to begin operation. When the battery voltage is low, there is no need for a low voltage diode, it is only necessary to have for a low forward voltage drop when the battery voltage is high, with sufficient voltage headroom from the solar array output voltage over the battery voltage to achieve the full charging current through the diode.

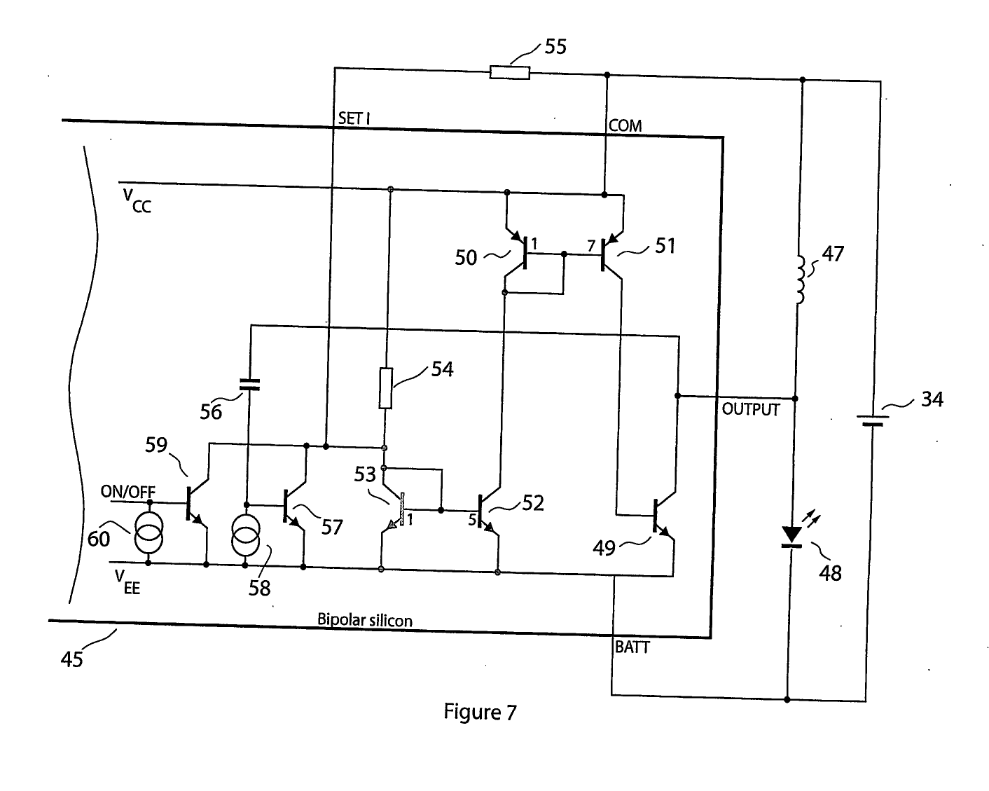

FIG. 7 shows an output drive circuit in which some useful design techniques available with integration into a silicon chip are used. In bipolar silicon circuits resistors occupy substantial area, and therefore cost disproportionately more as their resistance values increase, whereas transistors con occupy minimal area when handling low currents. So the circuit shown in FIG. 7 has only one resistor, and a larger number of transistors.

In addition this circuit takes advantage of the use of current mirrors to provide current sources that are a ratio of the input current.

The circuit incorporated in the bipolar silicon chip is enclosed in a box 45. The battery, choke and Light emitting diode are external to the control circuit as was described in FIG. 3.

The output transistor 49 is driven from a current mirror made up of PNP transistors 50 and 51. The emitter area, and therefore the resulting collector current of transistor 51 is shown as being 7 times that of diode connected transistor 50. Therefore the base current drive of the output transistor 49 will be seven times larger than the current driving the current mirror from transistor 52.

The transistor 52 is also the output transistor of a current mirror with transistor 53, this time NPN, with a current ratio of five. The diode connected transistor 53 is diode connected and its current is supplied through resistor 54. This resistor provides the smallest useable base drive, which when amplified by the current mirrors provides the base drive current of the output drive transistor 49.

To permit external setting of this current drive, and therefore adjustment of the point at which output transistor 49 begins to leave saturation, and its collector voltage begins to rise, provision is made for an external resistor to be connected in parallel to the resistor 54. This external resistor will be chosen to set the peak current level at which output transistor 49 begins to leave saturation, ending of the time period during which the output transistor has been on, and current in the choke increasing.

The oscillator circuit is completed by the feedback capacitor 56 connected to the base of transistor 57. When the capacitor 56 applies a positive going edge to transistor 57, the collector pulls the current in resistors 54 and 55 that are driving the collector and base connection of transistor 53 down to VEE, cutting transistor 53 off. This cuts off the current drive for the output transistor 49, and allows the output voltage to rise sufficiently to forward drive the Light Emitting Diode.

A small current source (or resistor) 58 normally pulls the base of the transistor 57 low, and the time constant of this current source 58 with the feedback capacitor 56 must be large enough for the circuit to operate as intended.

ON/OFF control is provided via transistor 59, and its associated current source 60. When this transistor 59 is ON, then the current in resistors 54 and 55 is again prevented from flowing in the diode connected transistor 53, and the output transistor is held off. In this condition the battery voltage will be present on the output terminal, and although slightly forward biased, this will not be sufficient voltage to exceed the forward knee of the Light Emitting Diode forward characteristic and the current flow in the LED will be insignificant.

It is possible to bring the connection of the capacitor 56 and the base of transistor 58 out of the IC to allow the capacitor to be replaced with an external capacitor to the integrated circuit. In integrated circuit design only low values of capacitance are feasible due to the large area required for a value of capacitance typical of a discrete circuit. Therefore access to this point is advantageous, not only because it would save the possible area occupied by the capacitor, but also because it would allow both the circuit of FIG. 1 and that of FIG. 2 to use the integrated circuit. Alternatively, another interconnection mask could be used to male a different chip in which the capacitor 56 is simply disconnected.

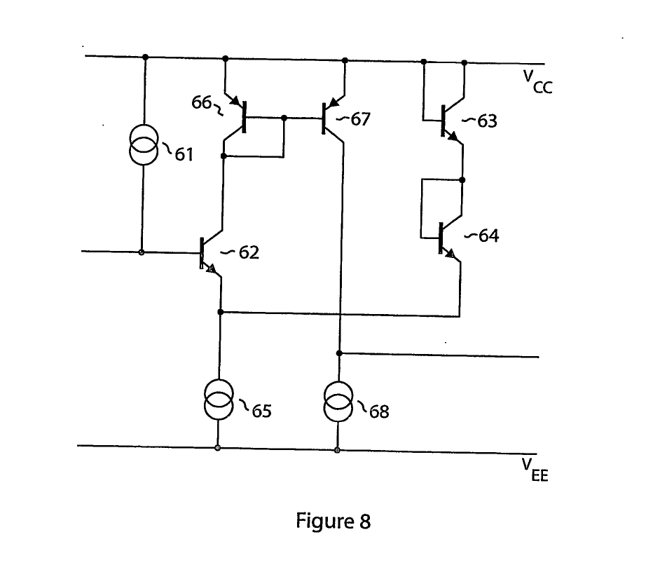

FIG. 8 shows a practical circuit realisation to provide a detection threshold for the input from the solar panel at an appropriate sensitivity to control the output drive at dusk. The solar panel connection and input pin of this circuit is pulled high by a small constant current supply 61. In integrated circuit design current sources occupy much smaller areas than high value resistances, and in addition have the advantage of offering a constant current over a range of voltages. With a resistor the current is proportional to the voltage, and if a higher voltage is applied under certain conditions, then the additional current is wasted.

The input transistor 62 senses the panel voltage on the base, and has its emitter connected to a reference voltage generated by two diode connected transistors 63 and 64 with the equivalent diode anode connected to the VCC supply rail. A constant current source 65 provides a forward bias current in the diode connected transistors 63 and 64, providing a bias voltage of 1.2 volts for the emitter of the input transistor 62. When the voltage on the input from the solar panel is more than one VBE positive with respect to the emitter voltage of this transistor: that is at 0.6 volts below the VCC rail, then the input transistor is turned on, and current flows in its collector.

This current is mirrored in the PNP transistor mirror pair made up of transistors 66 and 67, pulling the light detection control output high whenever the mirrored current exceeds the current available from the current source 68.

This circuit provides a sensitive light level detection circuit having a threshold voltage of 0.6 volts below (negative with respect to) the VCC supply rail, pulled high by a constant current source of typically about 3 microamps. It has a very high input impedance, and presents very little loading on the output of the solar panel.

As the solar panel characteristic provides a high impedance current source with an output current proportional to the low levels of incident light. At the low light levels where it is preferred to set the switching threshold, the high impedance characteristic matches that of the input to the threshold detector the constant current output drive is matched to the current source 61 at this threshold. As the light increases, generating more panel current, the panel output voltage rapidly increases negatively (referenced to VCC) until the input circuit starts to conduct and the battery is being charged.

This switching threshold has been found to be most appropriate for lamps that turn on very close to darkness, at the time that their light contribution will be noticeable. Other circuits, for example that shown in FIG. 2, turn on at a high level of incident light, and are regarded as not being as sensitive to light as is preferred in the market place.

If it is felt to be necessary to change the light threshold, an external resistor may be connected from VCC to the panel input connection to provide an additional current load to change the threshold.

In FIGS. 5 and 6 a circuit providing a basic active charging circuit was described, to provide a means of charging the nickel cadmium stored charge cell with a minimum voltage drop across the transistor pass element.

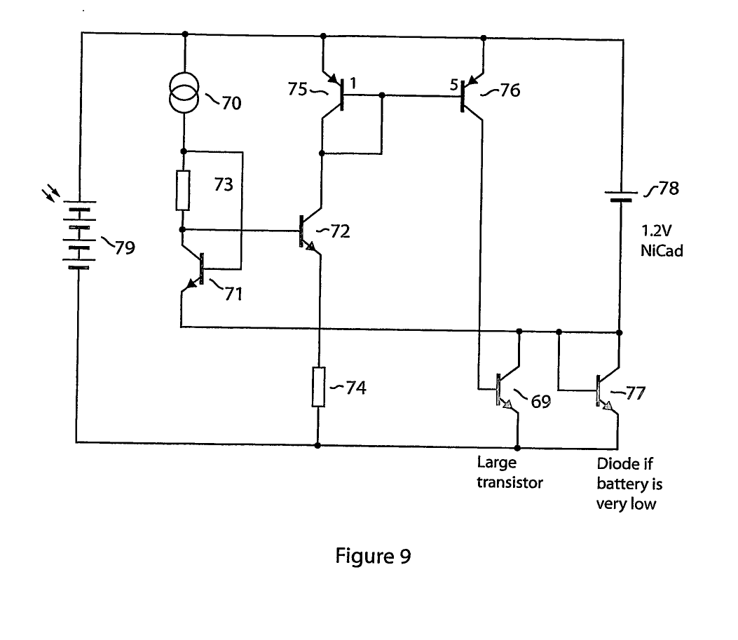

This is further developed in the circuit shown in FIG. 9. This has been designed to provide sufficient base current to the large transistor 69 to drive it into a reasonably low saturation voltage, and yet at the same time, to not waste charging current by offering base current beyond that which would be needed in a reasonable design. The aim of the design is to maintain good performance as assessed by measuring the voltage drop across the control transistor 69, while keeping the base current below about 2% of the total current flow.

The circuit of FIG. 9 achieves this. The solar panel 79 drives the emitter of the high current pass transistor 69, which is driven into near saturation by the drive regulating circuit, allowing current from the solar panel to charge the Nickel Cadmium battery 78 with minimal voltage drop across the pass transistor.

A current source 70 provides a bias current for a diode connected transistor 71 to give a base voltage to the bias generating transistor 72. The voltage across the bias transistor 71 provides a diode VBE voltage about 0.6 volts positive with respect to the negative supply rail VEE (connected to the negative side of the Nickel Cadmium battery cell 78). Some resistance 73 is included in series with the collector connection of the diode connected transistor 71. This allows the voltage on the base of transistor 72 to be reduced from the initial VBE of diode transistor 71, and to fall further as the base current in transistor 72 increases. Furthermore a resistor in the emitter of transistor 72 provides a further voltage drop to further increase the VCE(SAT) voltage across to a reasonable starting level of around 50 millivolts when the current carrying transistor 69 begins to conduct.

The collector current of transistor 72 is mirrored and amplified by the current mirror made up of transistors 75 and 76, which are ratioed to give 5:1 current amplification by using 5 multiple emitters in transistor 76 compared to the single emitter of transistor 75.

The output from the collector of transistor 76 becomes the base drive of the main current carrying transistor 69.

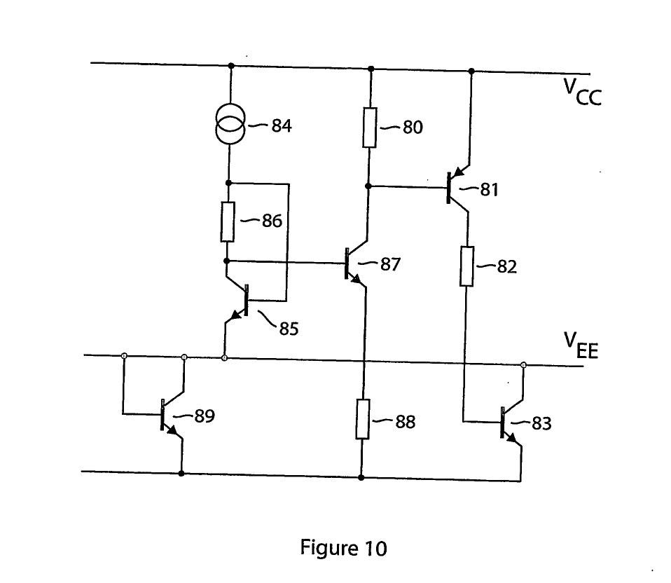

FIG. 10 shows a final practical realisation of this circuit, where the current mirror of FIG. 9 has been replaced by a transistor amplifier made up of PNP transistor 81 and leakage cancelling resistor 80 across its emitter base. A current limiting resistor 82 is included in the collector output driving the bass of the large pass transistor 83. The current source, diode connected transistor 85, collector resistor 86, bias transistor 87, and its emitter resistor 88, function in the same way as has been described for circuit in FIG. 9.

Diode 89 is a small signal transistor, diode connected, so that if the Nickel Cadmium battery is fully discharged, and there is no base drive available for transistor 83, then there is a diode path available to start charging the battery. Once there is a sufficient voltage across VCC to VEE (more than 800 millivolts) then the charging circuit will begin to function normally, the charging transistor 83 will be turned on, and the diode 89 will no longer conduct.

In the integrated circuit which has been constructed using this circuit, the current source 84 provides a bias current of typically about 6 microamps. Resistor 86 is 2.5 kilohms, and resistor 88, 500 ohms.

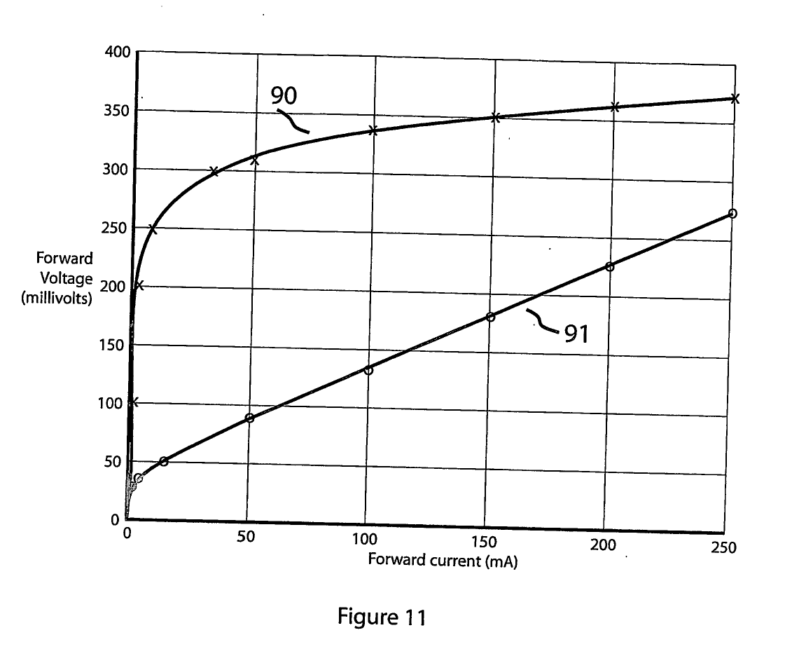

FIG. 11 shows a graph of the forward voltage drop against current for the circuit of FIG. 10 (curve 91) against the characteristic of a typical Schottky diode (curve 90). It is evident that at 100 mA the typical forward voltage drop of the Schottky diode is about 340 millivolts. In curve 91 the graph showing the typical performance of the integrated circuit incorporating the charging circuit of FIG. 10 has a saturation voltage drop at 100 mA of only 140 millivolts, with less than 1% of the current being used to provide its base drive.

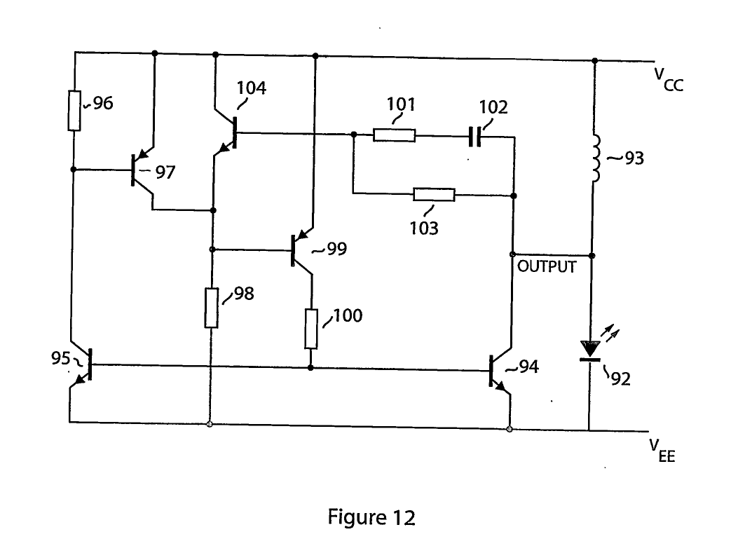

The oscillator and output drive circuit 7 has been improved in the suggested circuit shown in FIG. 12. In this circuit the Light Emitting Diode 92 and inductance 93 are external to the integrated circuit controller, and are driven by the large area, low VCE(sat) output transistor 94. The drive to this transistor 94 is arranged from the small parallel current mirror transistor 95, the collector current of which is a fraction of the collector current in the output transistor 94 determined by the emitter area ratio of the two transistors 94 and 95. Its collector current drives the base of transistor 97 and resistor 96. The collector current of transistor 97 controls the base current available for the transistor 99 which provides the main output transistor's base drive current. The drive for transistor 99 is provided by the current in resistor 98, less any control loop current that is bled away by transistor 97. Resistor 100 provides a current limiting resistor.

Oscillator feedback is provided by the series resistor 101 and capacitor 102 to the base of transistor 104. A parallel resistance 102 provides the dc base current needed by the feedback transistor 104. The current drive to the output transistor 94 is limited, and its collector current increases at a rate determined by the series inductor 93 connected to VCC. This increase is proportional to the supply voltage, and the inductance (V=L.di/dt) so that the collector voltage of this transistor will increase more rapidly when it begins to pull out of saturation once the base current is no longer sufficient to hold it well in saturation. This increasing voltage is ac coupled by the capacitor 102 to the base of transistor 104, turning this transistor on. The collector current of this feedback transistor subtracts from the current available as base drive to the control transistor 99, reducing the base current available to the output transistor 94. This accelerates the action of this transistor becoming unsaturated, and accelerates the increase in collector voltage, rapidly cutting the transistor off altogether. The reduction in collector current in the inductance 93 will cause the voltage on the output to rapidly increase until the light emitting diode 92 begins to conduct, maintaining the current flow in the inductor.

Therefore once the output transistor is cut off, the inductive current will be driven through the light emitting diode, with the current decreasing at a rate determined by the inductance and the voltage across the inductor (that is (VLED−Vbatt)=L.di/dt). Furthermore the large increase in the collector voltage of the output transistor 94 will have presented a similar positive edge to the feedback transistor 104, causing it to reverse bias the base of the control transistor 99. As the current in resistor 98 is flowing in the feedback transistor 104 at this time, the base current of this transistor 104 will discharge the capacitor 102, until the current is no longer sufficient to hold the control transistor 99 off. It will start to switch on again after an off period set by the capacitance value and the rate at which it is discharged via resistor 98 and feedback transistor 104's current gain: current will again flow in output transistor 94 as it goes back into saturation again, and it will pull the output connection of the junction of the inductor 93 and LED 92 back down almost to VEE. Current will begin to increase through the inductor, ready to continue with the next cycle.

Thus the output transistor is on for a period of the time required for the current in the inductor to build up to the point where the transistor starts to pull out of saturation, it then switches off for a period determined mainly by the capacitance 102 and its discharging current, during which time the falling inductor current flows through the LED illuminating it for that part of the duty cycle.

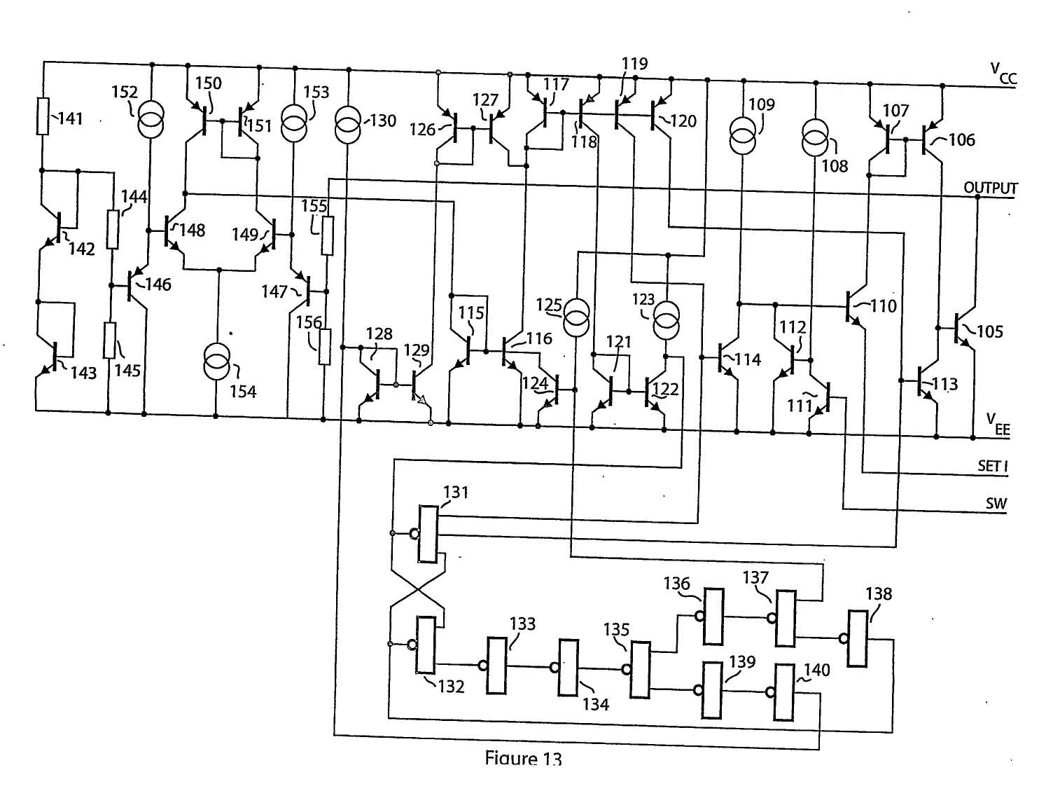

In FIG. 13 we see the developed oscillator and output drive circuit used in the integrated circuit chip realisation of this project. The large area output transistor 105 is turned on by the current mirror made up of transistors 107 and 106. Their current drive is provided by transistor 110 with its base driven by current source 109. The current drive is set by an external resistor (not shown) which is connected from the SET I pin (the emitter of transistor 110) to VEE.

This drive for the output transistor is able to be switched off by the SW control signal from the circuit shown in FIG. 8, which turns off transistor 111, allowing current source 108 to turn on transistor 112, pulling down the base of drive transistor 110, and preventing any current drive being available to the current mirror and output transistor. Alternatively it can be switched off by transistor 114.

To assist in turn-off, and to speed up the switching of the output transistor 105, the base of the output transistor 105 may also be pulled low to VEE by transistor 113.

The turn-off signals are obtained from a pulse generating circuit utilising integrated injection logic (IIL or I2L) gates.

Transistors 115 to 122, 124, and 126 to 129, current sources 123, 125 and 130, and injection logic gates 131 to 140 control the on/off switching of the output transistor 105. When the collector of transistor 105 pulls out of saturation, and when its collector voltage reaches a certain voltage (typically about 0.3 volts) then a latch is set, the output transistor is turned off, and a fixed period pulse generated from the injection logic gate delay line, that resets the latch at the end of the pulse time.

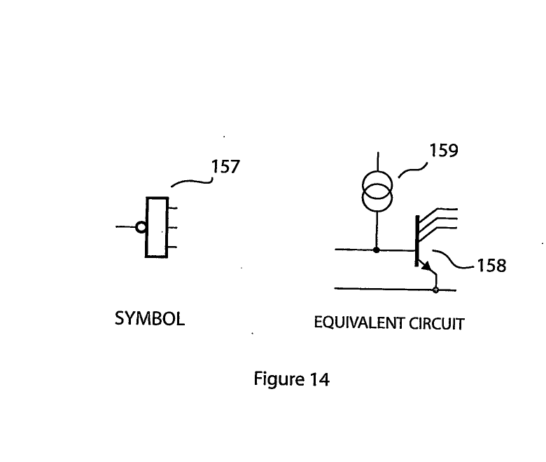

In FIG. 14 the symbol 157 for an injection logic gate is shown. This example has a single input and three outputs. Integrated injection logic differs from most other gates that a designer is accustomed to using in that it has a single input connection, with multiple output connections. It is not permitted to connect two gate inputs together in an injection logic circuit, while outputs are permitted to be connected in common. This is the reverse of the commonly used CMOS or TTL gate, where inputs are often connected, but outputs cannot be joined.

An equivalent circuit of the gate structure is also shown in FIG. 14. The outputs are the open collectors of an NPN transistor 158, having a current source base drive 159. If the base input is high, and is not held low, then the transistor is turned on, and all of the three collector outputs shown are pulled low. In physical construction the base current source is generated by a PNP structure made up of a p-type junction bar that is common to all gates. It injects into the n-type region that makes up the emitter of the NPN transistor 158. The base of the NPN transistor is p-type, and completes the PNP structure of the injector structure.

A further difference to normal circuit design practice is the use of an inverse structure for the NPN transistor 158. In a normal NPN planar structure in a bipolar integrated circuit the collector is the n-type island, in which a p-type region is diffused to form the base, with an n-type emitter diffused into the base region. This has high gain in the forward direction, and poor inverse gain when it is used in a circuit with the collector and emitter function reversed. If normal transistors are connected in a circuit with parallel transistors offering multiple output collectors as is shown for transistor 158 current hogging occurs. If one collector is allowed to pull low into deep saturation its VBE is modified, greatly reducing the available base current and output pull-down current available at the collector output of the other transistor(s) that is not in saturation.

However, when it is inversely connected, the forward gain is low and the problem of current hogging is greatly reduced. This inverse structure enables the n-type island to become the emitter for all three transistors, and multiple small n-type diffused regions in the p-type base are be used as the collector outputs. This offers a small and compact layout for each gate. The low gain is not a problem. As long as it is sufficient for the pull down capability of each collector to be greater than the injector current source of the following (single) gate input, it provides a compact logic capability for bipolar technology, with an excellent power speed product. In the circuit shown in FIG. 13 the injector current is 18 microamps powering the 10 gates shown in this circuit.

In this circuit when the collector of the output transistor begins to pull out of saturation, a threshold detector detects this and drives a current into the diode connected transistor 115. This is mirrored in transistor 116, providing a current source from VEE to drive the current mirror on VCC consisting of diode reference PNP transistor 117, and three mirrored outputs from VCC from transistors 118, 119, and 120. Thus when current flows into diode connected transistor 115, these three transistors (118 to 120) provide mirrored current sources from VCC equal to this input current.

The first of these outputs from transistor 118 is again mirrored with respect to the negative rail VEE, by diode connected transistor 121 and the mirror transistor 122, and current source 123, providing a control signal to pull down the first injection logic gate input 131. Until the current flows in the mirror circuit, and transistor 122 pulls the input to gate 131 low, the input to gate 131 is high if gate 132 permits and is not pulled low by having a high signal on its input.

Injection logic gates 131 and 132 are connected as a cross-coupled latch. When the input to gate 131 is pulled low, its outputs are able to be pulled high, unless there is another output still holding it low.

The three outputs of gate 131 act as follows: the first, connected to the base of transistor 114, and current mirror transistor 119, allows the current drive from 119 to turn transistor 114 on, cutting off transistor 110, and preventing the current flow that was previously driving the output transistor, thus turning off the output drive transistor 105.

The second output similarly drives the base of transistor 113, and allows the current source 120 to turn this transistor 113 on. This pulls down the base of the output transistor, ensuring that it is turned off quickly, and assisting to remove the stored charge that extends the turn-off delay.

The third output is connected to the input of gate 132 (making up the cross-coupled latch), and also the output from gate 138. At the time when the input of gate 131 is pulled low, the output of 138 is high. So at this time only the output of 131 is pulling the input of 131 low, and this connection is able to go high when transistor 122 pulls the input of 131 low.

When the input of 132 goes high, its outputs are pulled low, one output also holding the input of 131 low until 132 releases it. The other output of 132 passes along a line of gates 133 to 138 inverting, and re-inverting the signal, as it passes along the line. Each gate delays the signal by its inherent gate delay, so after seven gate delays the signal starting from the output of 132 arrives at the output of 138 and is applied back to the input of 132 to pull its input low.

Once the input of gate 132 is pulled low by the output of gate 138 the latch will be switched back if the output of transistor 122 driving gate 131 is permitted to go high. This is arranged by taking a second output of gate 137 with a current source 125 to drive the base of transistor 124 and turn off the signal of current mirror transistors 115 and 116 which conduct when the voltage on the collector of output transistor 105 is above the threshold.

To enhance the switching speed, this function is duplicated through another path from gates 139 and 140, Current source 130 driving the current mirrors made up of NPN transistors 128 and 129, and PNP mirror transistors 126 and 127 which hold off the base drive to transistor 117.

The final section of this circuit is the threshold detector which needs special design approach to ensure performance at low supply voltages, and low ambient temperatures. A reference voltage is provided by resistor 141 and resistive divider 144 and 145. The voltage across the resistors 144 and 145 is clamped to be no more than 2 VBEs (about 1.2 volts) by two diode connected transistors 142 and 143.

This reference voltage is applied to a long tail differential amplifier made up of a PNP input transistor on each side (146 and 147) with current sources 152 and 153 biasing its emitter follower output. This is applied to the NPN long tailed pair, that is the bases of transistors 148 and 149, whose common emitter current is provided by current source 154.

The collector load of this balanced transistor pair is provided by the current mirror transistors 151 and 150, providing a current output drive to the pulse generating circuit beginning with the diode connected transistor 115.

This circuit has been constructed to operate within a low voltage supply rail. The minimum operating voltage is set by the necessary VBE voltage needed by the amplifier transistors. By nesting the VBE of NPN and PNP transistors within each other, operation can be maintained down to a voltage of one VBE plus the saturation voltage of two transistors. That is to about 0.6 volts plus two 0.1 volt saturation levels.

The threshold at which this circuit is required to switch, that is the voltage when the output drive transistor 105 begins to pull out of saturation at high current levels (up to a typical peak current of 150 mA) is typically 0.3 volts. If this is added to a VBE, and one saturation voltage this gives a minimum operating supply voltage of 1.0 volt (0.3 threshold, +0.6 VBE (transistor 147), −0.6 VBE (transistor 149)+0.1 VCE(sat) (transistor 149)+0.6 VBE (transistor 151)). Of these only the 0.3 threshold can be reduced by adopting a different design approach. Therefore to allow operation below 1 volt, a voltage divider made up of resistors 155 and 156 needs to be applied to the signal derived from the collector of output transistor 105, to reduce this desired trip point voltage to 150 mV before it is applied to the differential amplifier. Thus by use of the voltage divider, the low voltage operating point is lowered from 1 volt to about 850 millivolts. As the VBE is temperature sensitive at typically −2 mV per degree Celsius, with this circuit operation at below 1 volt can be maintained to a temperature below −40 degrees.

Throughout this specification the purpose of the description has been to illustrate the invention and not to limit this.

1. A solar powered lamp arrangement where there is a solar photo-voltaic panel array controllably connected to a battery storage providing with such control a supply of direct current to at least one light emitting diode, and a switching arrangement with means to detect in connection with any electrical supply status from the array that this is below a selected threshold value, and such that the switching arrangement is adapted to effect, upon the said means detecting said lower than said threshold value status, an electrical connection between at least one said light emitting diode and the battery storage so that the light emitting diode or diodes will thereby be connected to effect a light output the arrangement being further characterised in that, in a supply connection from the solar panel array to the light emitting diode or diodes there is a further unidirectional current conducting unit which is not a Schottky diode.

2. The arrangement of claim 1 wherein the unidirectional current conducting unit is a transistor and means to maintain this when operating in a mode close to saturation mode.

3. The arrangement of claim 2 wherein the close to saturation mode is maintained by providing a drive applied to the transistor which is less than 3% of a charging current being applied to the battery storage.

4. The arrangement of claim 1 wherein the unidirectional current conducting unit is an integrated circuit adapted to provide a unidirectional effect.

5. The arrangement as in claim 4 wherein a positive output of the battery storage and a positive terminal of the solar panel array are electrically connected in common.

6. The arrangement as in claim 5 wherein the unidirectional current conducting unit includes an input transistor connected to an output of the solar array, and a voltage reference means which are adapted to effect selection of the threshold value.

7. The arrangement as in claim 6 wherein the voltage reference is voltage divider.

8. The arrangement as in claim 6 wherein the voltage reference includes at least one diode connected transistor and a current source.

9. The arrangement as in claim 6 wherein the input transistor is an NPN transistor.

10. An arrangement as in claim 1 further including circuitry adapted to convert a direct current voltage drawn from the battery storage to an alternating current of higher voltage and to supply such higher voltage to the light emitting diode.

11. The arrangement of claim 10 wherein said higher voltage is connected so that it will be applied directly to the light emitting diode or diodes and the light emitting diode or diodes then are without any storage capacitor across any respective diode.
